(19) United States
(12) Patent Application Publication
(10) Pub. No.: US 2013/0309647 A1
(43) Pub. Date: Nov. 21, 2013

(54) Methods and Systems for Educational On-Line Methods

(71) Applicant: University of North Carolina at Greensboro, Greensboro, NC (US)

(72) Inventors: Eric Ford, Greensboro, NC (US); Dimytro Babik, Greensboro, NC (US)

(73) Assignee: University of North Carolina at Greensboro, Greensboro, NC (US)

(21) Appl. No.: 13/893,938

(22) Filed: May 14, 2013

Related U.S. Application Data
(60) Provisional application No. 61/646,640, filed on May 14, 2012.

(51) Int. Cl. G09B 5/00

(52) U.S. Cl. CPC G09B 5/00
USPC 434/350

(57) ABSTRACT

A Double-Loop Mutual Assessment (DLMA) method may assess complex, non-objective, content. For example, a DLMA method can use formative and summative peer assessment to generate textual feedback and/or numeric success metrics. One or more DLMA methods can be used in any number of situations. For example, one or more DLMA methods may be used in online courses, in-person courses, blended courses, written submissions, consumer assessment of products and/or services, performance evaluation, assessing individual contributions to group projects, and/or other tasks.

### CROSS-REFERENCE TO RELATED APPLICATION

This application claims priority under 35 U.S.C. §119(e) to U.S. Provisional Application No. 61/646,640, filed May 14, 2012, entitled “Methods and Systems for Educational On-Line Methods,” the entirety of which is hereby incorporated reference.

### FIELD OF THE INVENTION

The present disclosure relates generally to methods and systems for educational on-line methods and more particularly relates to assessing outcomes of complex task competencies among participants.

### BACKGROUND

Historically, the ability to assess and empirically demonstrate competencies, attainment, and/or improvement of an individual within a given population has been difficult. Similarly, the ability to assess and empirically demonstrate competencies, attainment, and/or improvement of groups within a population has also been difficult. Systems and methods that enable competencies, attainment, and/or improvement of an individual within a given population and/or a group within a given population to be assessed and/or empirically demonstrated would be advantageous. In addition, systems and methods that improve complex task performance, mitigate deficiencies in existing peer assessment systems, and/or enable large-scale evolutions involving one or more participants would be advantageous.

### SUMMARY

Embodiments of the present invention provide systems and methods for assessing outcomes of complex task competencies. For example, in one embodiment of the present invention, a Double-Loop Mutual Assessment (DLMA) method is usable as a peer assessment tool. In an embodiment, one or more DLMA methods can help to assess outcomes of complex task competencies, such as expertise, among participants. In one embodiment, a DLMA method uses both formative and summative peer assessments to generate feedback and success metrics. For example, a DLMA may provide textual feedback and numerical scores for one or more participants. DLMA methods can be designed to be and may be applicable to any number of settings. For example, in various embodiments, one or more DLMA methods may be used to qualitatively grade courses. A course may be an online course or an in-class course, or a combination thereof. In other embodiments, one or more DLMA methods can be used to select academic journal articles and/or conference submissions. As another example, one or more DLMA methods may be used to assess individual performance on a series of complex tasks in social settings, assess individual contributions to group projects, evaluate an individual or group's performance, assess products and/or services for one or more consumers, assess collaborative environments such as a collaborative online encyclopedia, build competency-based social systems of learning such as creative writing or photography or art courses, and/or numerous other complex tasks.

These illustrative embodiments are mentioned not to limit or define the invention, but rather to provide examples to aid understanding thereof. Illustrative embodiments are discussed in the Detailed Description, which provides further description of the invention. Advantages offered by various embodiments of this invention may be further understood by examining this specification.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is a DLMA workflow according to an embodiment of the present invention;

FIG. 2 is a block diagram depicting an exemplary requesting or receiving device according to an embodiment;

FIG. 3 is a system diagram depicting exemplary computing devices in an exemplary computing environment according to an embodiment;

FIG. 4 illustrates a method of implementing a DLMA workflow according to an embodiment of the present invention;

FIG. 5 illustrates a workflow schema of a Double-Loop Mutual Assessment (DLMA) Peer Assessment Information System (PAIS) according to an embodiment of the present invention

FIG. 6 illustrates a logical relationship of algebraic models of a DLMA score generation process according to an embodiment of the present invention; and

FIG. 7 illustrates an exemplary dyad formation in closed groups and on networks according to an embodiment of the present invention.

### DETAILED DESCRIPTION

Example embodiments are described herein in the context of assessing outcomes of complex task competencies among participants. Those of ordinary skill in the art will realize that the following description is illustrative only and is not intended to be in any way limiting. Other embodiments will readily suggest themselves to such skilled persons having the benefit of this disclosure. Reference will now be made in detail to implementations of example embodiments as illustrated in the accompanying drawings. The same reference indicators will be used throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

### Overview

One or more DLMA methods may help to assess outcomes of one or more complex tasks. In one embodiment, a complex task is characterized by various combinations of complexity attributes. For example, complexity attributes may include, but are not limited to, such attributes as outcome multiplicity, solution scheme multiplicity, conflicting interdependence, and solution scheme and/or outcome uncertainty. In various embodiments, complex tasks can include, but are not limited to, writing essays, creating compositions, and/or producing academic articles.

In an embodiment, a DLMA method is based on a workflow that facilities formative assessment and/or summative assessment. In one embodiment, formative assessment provides a set of formal and/or informal evaluation procedures with the intent of improving a subject's competencies through behavior modification. For example, formative assessment may provide results using qualitative feedback. In an embodiment, summative assessment is intended to measure a subject's attainment at a particular time. For example, summative assessment may provide external accountability in the form of a score and/or a grade. In various embodiments, one or more modes of DMLA may be used. In one embodiment, a mode of DLMA is a type of scale that is used for summative assessment. For example, ranking and/or rating are examples of modes of DMLA according to an embodiment. In one embodiment, ranking provides a summative assessment mode based on a relative scale, forced distribution, and/or another suitable scale and/or distribution. In an embodiment, rating provides a summative assessment mode based on an absolute-scale, Likert-scale, or another suitable scale and/or distribution.

In assessing outcomes of one or more complex tasks, peer assessments may be involved. In one embodiment, a peer assessment is an arrangement of assessment in which subjects consider the products and/or outcomes of peer subjects of similar status. For example, subjects may consider the amount, level, value, worth, quality, success, other factors, or a combination thereof of the products and/or outcomes of peer subjects. In embodiments, feedback is provided as part of peer assessment. In one embodiment, the feedback provides an instance of formative assessment which is given by one peer to another. For example, a subject may provide a written statement regarding the quality of another subject's essay. In another embodiment, feedback, such as gauging and/or feedback evaluation, provides an instance of summative assessment given by one peer to another peer.

### Illustrative DLMA Workflow

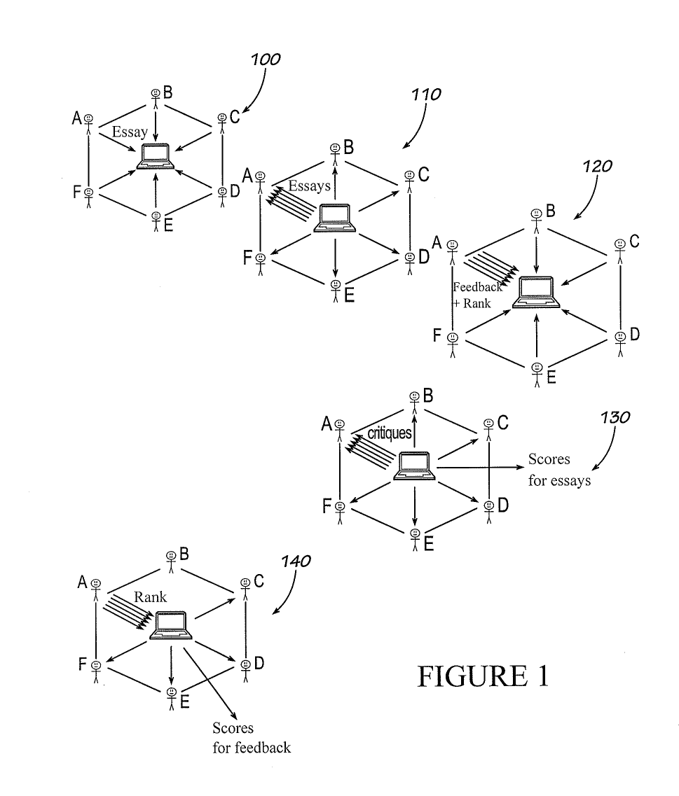

FIG. 1 is a DLMA workflow according to an embodiment of the present invention. In the embodiment shown in FIG. 1, a classroom of students are divided into groups of six students. Each group is given an assignment to complete. For example, a group may be assigned an article to read, perform a case analysis on, and draft an essay having 750 words or less regarding the article and case analysis. The assignment can be the same for each group or one or more of the groups can have different assignments. Each student in each group completes the assignment. For example, each student in the group may write an essay 100. The essays that the students write can be submitted through an online website to one or more databases. The students then evaluate the essays of other students in their group 110. For example, if a group contains six students, then one student in the group may evaluate the essays of the other five students in the group. The student may rank the other students' essays from best to worst and may provide written feedback regarding the strengths and weaknesses of the other students' essays 120. A student's evaluations of the other students' essays in the group can be submitted through the online website and stored in one or more databases. The students in the group then receive feedback regarding their essay and scores for the essays are generated 130. The students in the group then evaluate the evaluations that they received from the other students in the group and score the evaluations 140. The rankings of the evaluations can be submitted through the online website and may be stored in one or more databases. This process may be repeated multiple times. For example, the same groups may be given a second assignment. As another example, the students in the classroom may be divided into new groups and given a second assignment. The results of a single assignment and/or multiple assignments can be evaluated to determine a ranking for the students. In addition, overall feedback can be provided to the students. For example, a particular student may be provided feedback indicating that he or she is writing essays very well but is ranking poorly in providing feedback for other students' essays.

This illustrative example is given to introduce the reader to the general subject matter discussed herein. The invention is not limited to this example. The following sections describe various additional non-limiting embodiments and examples of devices, systems, and methods for content- and/or context-specific haptic effects.

### Illustrative Device

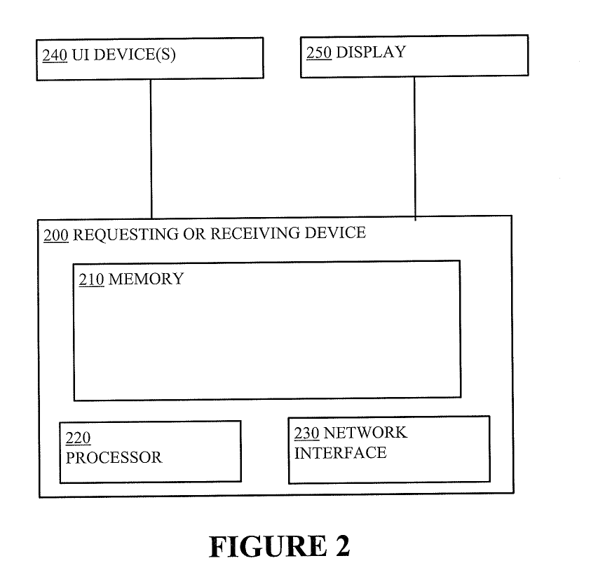

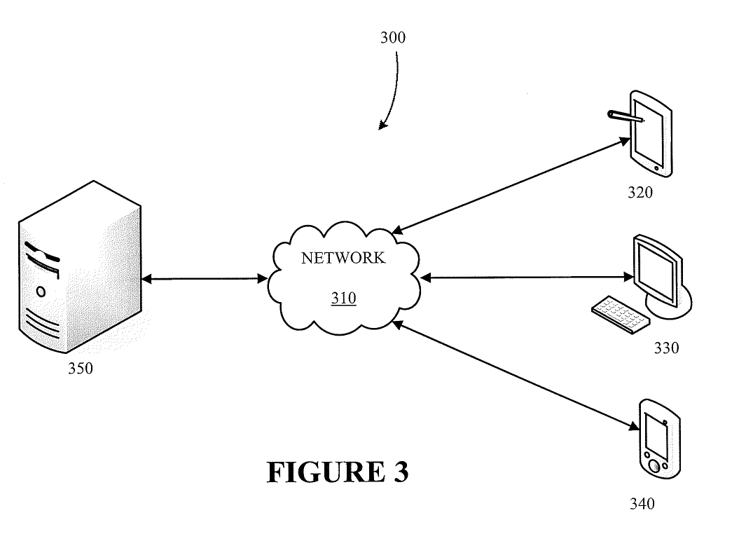

FIG. 2 is a block diagram depicting an exemplary requesting or receiving device according to an embodiment. For example, in one embodiment, the device 200 may be a web server, such as the web server 350 shown in FIG. 3. In other embodiments, device 200 may be a client device, such as the client devices 320-340 shown in FIG. 3. In various embodiments, device 200 may be a tablet computer, desktop computer, mobile phone, personal digital assistant (PDA), or a sever such as a web server, media server, or both.

As shown in FIG. 2, the device 200 comprises a computer-readable medium such as a random access memory (RAM) 210 coupled to a processor 220 that executes computer-executable program instructions and/or accesses information stored in memory 210. A computer-readable medium may comprise, but is not limited to, an electronic, optical, magnetic, or other storage device capable of providing a processor with computer-readable instructions. Other examples comprise, but are not limited to, a floppy disk, CD-ROM, DVD, magnetic disk, memory chip, ROM, RAM, SRAM, DRAM, CAM, DDR, flash memory such as NAND flash or NOR flash, an ASIC, a configured processor, optical storage, magnetic tape or other magnetic storage, or any other medium from which a computer processor can read instructions. In one embodiment, the device 200 may comprise a single type of computer-readable medium such as random access memory (RAM). In other embodiments, the device 200 may comprise two or more types of computer-readable medium such as random access memory (RAM), a disk drive, and cache. The device 200 may be in communication with one or more external computer-readable mediums such as an external hard disk drive or an external DVD drive.

The embodiment shown in FIG. 2, comprises a processor 220 which executes computer-executable program instructions and/or accesses information stored in memory 210. The instructions may comprise processor-specific instructions generated by a compiler and/or an interpreter from code written in any suitable computer-programming language including, for example, C, C++, C#, Visual Basic, Java, Python, Perl, JavaScript, and ActionScript®. In an embodiment, the device 300 comprises a single processor 220. In other embodiments, the device 200 comprises two or more processors.

The device 200 as shown in FIG. 2 comprises a network interface 230 for communicating via wired or wireless communication. For example, the network interface 230 may allow for communication over networks via Ethernet, IEEE 802.11 (Wi-Fi), 802.16 (Wi-Max), Bluetooth, infrared, etc. As another example, network interface 230 may allow for communication over networks such as CDMA, GSM, UMTS, or other cellular communication networks. The device 200 may comprise two or more network interfaces 230 for communication over one or more networks.

The device 200 may comprise or be in communication with a number of external or internal devices such as a mouse, a CD-ROM, DVD, a keyboard, a display, audio speakers, one or more microphones, or any other input or output devices. For example, the device 200 shown in FIG. 2 is in communication with various user interface devices 240 and a display 250. Display 250 may use any suitable technology including, but not limited to, LCD, LED, CRT, and the like.

Device 200 may be a server, a desktop, a personal computing device, a mobile device, or any other type of electronic devices appropriate for providing one or more of the features described herein.

### Illustrative System

FIG. 3 illustrates a system diagram depicting exemplary computing devices in an exemplary computing environment according to an embodiment. The system 300 shown in FIG. 3 includes three client devices, 320-340, and a web server 350. Each of the client devices, 320-340, and the web server 350 are connected to a network 310. In this embodiment, each of the client devices, 320-340, is in communication with the web server 350 through the network 310. Thus, each of the client devices, 320-340, can send requests to the web server 350 and receive responses from the web server 350 through the network 310.

In an embodiment, the network 310 shown in FIG. 3 facilitates communications between the client devices, 320-340, and the web server 350. The network 310 may be any suitable number or type of networks or links, including, but not limited to, a dial-in network, a local area network (LAN), wide area network (WAN), public switched telephone network (PSTN), the Internet, an intranet or any combination of hard-wired and/or wireless communication links In one embodiment, the network 310 may be a single network. In other embodiments, the network 310 may comprise two or more networks. For example, the client devices 320-340 may be connected to a first network and the web server 350 may be connected to a second network and the first and the second network may be connected. Numerous other network configurations would be obvious to a person of ordinary skill in the art.

A client device may be any device capable of communicating with a network, such as network 310, and capable of sending and receiving information to and from another device, such as web server 350. For example, in FIG. 3, one client device may be a tablet computer 320. The tablet computer 320 may include a touch-sensitive display and be able to communicate with the network 310 by using a wireless network interface card. Another device that may be a client device shown in FIG. 3 is a desktop computer 330. The desktop computer 330 may be in communication with a display and be able to connect to the network 310 through a wired network connection. The desktop computer 330 may be in communication with any number of input devices such as a keyboard of a mouse. In FIG. 3, a mobile phone 340 may be a client device. The mobile phone 340 may be able to communicate with the network 310 over a wireless communications means such as TDMA, CDMA, GSM, or WiFi.

A device receiving a request from another device may be any device capable of communicating with a network, such as network 310, and capable of sending and receiving information to and from another device. For example, in the embodiment shown in FIG. 3, the web server 350 may be a device receiving a request from another device (i.e. client devices 320-340) and may be in communication with network 310. A receiving device may be in communication with one or more additional devices, such as additional servers. For example, web server 350 in FIG. 3 may be in communication with another server that encodes or segments, or both, media content from one or more audio or video inputs, or both. In this embodiment, the web server 350 may store the segmented media files on a disk drive or in cache, or both. In an embodiment, web server 350 may be in communication with one or more audio or video, or both, inputs. In one embodiment, a web server may communicate with one or more additional devices to process a request received from a client device. For example, web server 350 in FIG. 3 may be in communication with a plurality of additional servers, at least one of which may be used to process at least a portion of a request from any of the client devices 320-340. In one embodiment, web server 350 may be part of or in communication with a content distribution network (CDN) that stores data related to one or more media assets.

### Illustrative DLMA According to an Embodiment

In one embodiment, a DLMA system is based on the workflow that facilitates two interdependent processes: (1) the exchange of essays and feedback among several subject in a small group or a network that accommodates a learning dialogue (e.g., formative assessment), and (2) score generating process that ultimately forms a distribution of a performance metric (e.g., summative assessment).

A DLMA workflow can function as a virtual social system with a certain structure and relationships. For example, a basic unit of interaction within DLMA is a dyad of subjects (i.e., subject i to subject j). In such an embodiment, the interaction within the dyad of subjects can involve a sequence of reciprocal exchanges for one or more assessed tasks. All or a portion of the sequence of reciprocal exchanges may be anonymous, non-anonymous, or a combination thereof. In one embodiment, the sequence of reciprocal exchanges involves representations of complex task solutions. The representation of a complex task may be referred to as an essay. In one embodiment, an essay comprises an instance of a complex task outcome being assessed. In another embodiment, a sequence of reciprocal exchanges includes formative assessment of and/or feedback to essays. In some embodiments, a sequence of reciprocal exchanges for one or more assessed tasks can include both essays and formative assessment of and/or feedback to essays.

According to one embodiment, each subject provides a summative assessment of other peers' essays according to various criteria and also provides a summative assessment of other peers' feedback according to certain criteria. These summative assessments can include perceptions, understanding, feedback, and/or other information that occurs between the subjects in the dyad. In one embodiment, the summative assessments are collected and analyzed. For example, one or more of the summative assessments may be converted to scores. In one embodiment, a score may be calculated according to one or more DLMA algorithms as disclosed herein or according to any other suitable algorithm(s). A pool of subjects—such as a class of students—can be divided into one or more groups having n subjects each. Thus, in this embodiment, each group consists of n!/2(n−2)! dyads, where n is the number of subjects. For example, a group of six students (i.e. n=6) comprises 15 dyads that engage in a virtually simultaneous interaction according to an embodiment. Subjects can be assigned to groups randomly, according to a matching algorithm determined by a system coordinator such as an instructor, or according to an algorithm selected by one or more applications being executed on an electronic device that is associated with a DLMA system. According to various embodiments, after a task has been completed, a new task may be assigned to the existing groups (i.e. the groups are held static) or to new groups that have been re-matched for the pool of subjects. The ensemble of these dyadic interactions within a peer group (the DLMA treatment), can then be repeated which may result in self-regulating learning and success metrics.

### Illustrative DLMA Workflow

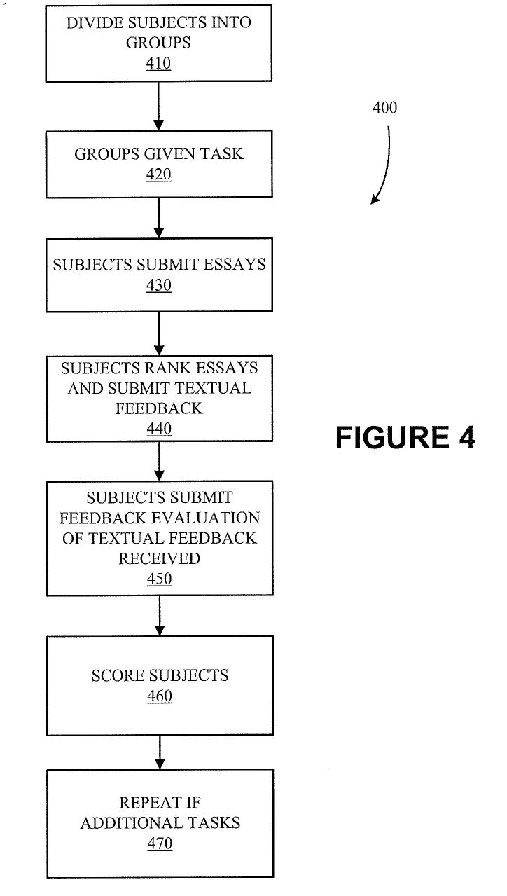

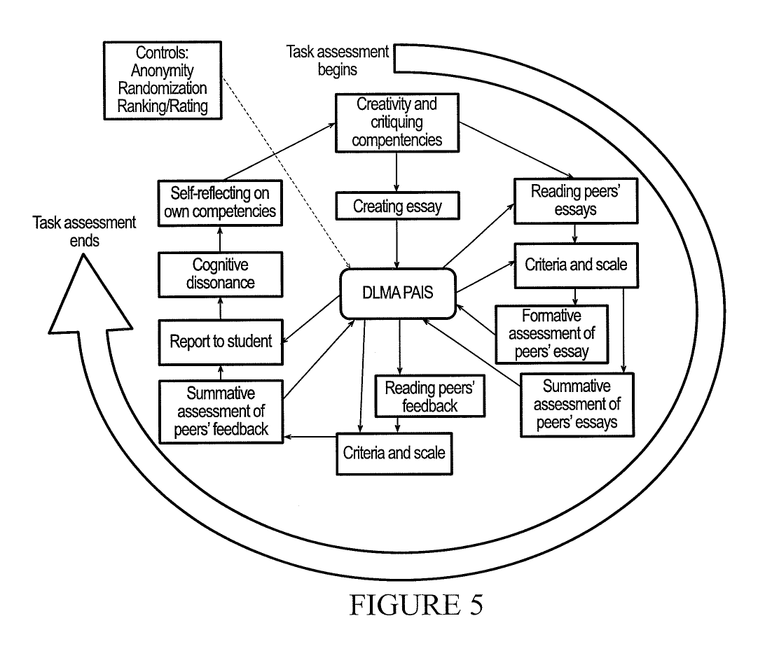

FIG. 4 illustrates a method of implementing a DLMA workflow according to an embodiment of the present invention. In embodiments, the method 400 shown in FIG. 4 is used to implement the workflow schema of a DLMA Peer Assessment Information System (PAID) as shown in FIG. 5. The method 400 shown in FIG. 4 will be described with respect to the electronic device 200 shown in FIG. 2. In embodiments, the method 400 may be performed by one or more of the devices shown in system 300 in FIG. 3. For example, one or more electronic devices 320-340 may perform all or a portion of the method 400 of FIG. 4 in accordance with embodiments of the present invention.

The method 400 beings in block 410 when a pool of subjects are divided into groups. For example, referring to FIG. 2, the electronic device 200 may receive a name for each of the subjects. In an embodiment, the electronic device 200 randomly divides the subjects into groups. In another embodiment, the electronic device 200 receives inputs that indicate which group each subject should be in. Thus, in this embodiment, the subjects are manually placed in groups by a user of the electronic device 200. In some embodiments, information regarding the subjects, group sizes, other constraints, group divisions, and/or other information may be received over a network. For example, referring to FIG. 3, tablet computer 320 may receive a list of subjects from web server 350 through network 310. In this embodiment, the web server may query a database to determine the list of subjects. The tablet computer 320 may divide the subjects into groups and send information back to the web server 350 indicating which group each subject should be associated with. Numerous other embodiments are disclosed herein and other variations are within the scope of this disclosure.

The pool of subjects may be divided into groups in any number of ways. In one embodiment, the pool of subjects are manually divided into groups. For example, an administrator of a task or another person authorized by the administrator of the task may divide the pool of subjects into groups. In another embodiment, the pool of subjects is divided into groups based on a DLMA algorithm or another algorithm. One or more computers can be used to divide the pool of subjects into groups according to embodiments of the present invention. For example, the pool of subjects may be randomly divided into groups.

In one embodiment, the number of subjects that can be assigned to a given group is determined by an administrator of a task. For example, a teacher may determine that each group should have eight students. In another embodiment, the number of subjects assigned to a given group is dynamically determined. For example, referring to FIG. 3, web server 350 may determine the number of subjects that can be assigned to a given group based on predefined settings, the number of subjects, received input, and/or other factors.

Referring back to method 400, once the subjects are divided into groups 410, the method 400 proceeds to block 420. In block 420, the groups are given a task. In one embodiment, each group is given the same task. For example, each group may be assigned an article to read and an essay to write about the article. In another embodiment, one or more groups are given different tasks. For example, if there are three groups, groups 1 and 2 may be given a first assignment and group 3 may be given a second assignment. As another example, if there are three groups, group 1 may be given a first assignment, group 2 may be given a second assignment, and group 3 may be given a third assignment. In one embodiment, one or more assignments may be given manually such as by an administrator of the assignment(s). In another embodiment, one or more assignments may be provided electronically. For example, referring to FIG. 3, web server 350 may send an assignment to tablet computer 320. In one embodiment, one or more assignments are selected by an electronic device 200 randomly. For example, a database may contain a plurality of available assignments and the electronic device 200 may query the database to determine one or more assignments. In another embodiment, an assignment may be chosen based at least in part on past performance of one or more subjects within a given group. Thus, if each subject in a group performed well on a previous assignment, then the group may be assigned a more difficult task. Numerous other embodiments are disclosed herein and variations are within the scope of this disclosure.

Referring back to method 400, once the groups have been given a task 420, the method 400 proceeds to block 430. In block 430, the subjects in the group(s) complete the task and the subjects submit essays regarding the task. For example, referring to FIG. 3, a subject of a particular group may complete the task assigned to that particular group and write an essay using desktop computer 330 regarding the task. In this embodiment, the subject may submit the essay to the web server 350 through network 310. In one embodiment, each subject for each group submits a separate essay. In another embodiment, a subset of the subjects for each group submits a separate essay. In some embodiments, if a subject does not submit an essay, then a particular value is assigned to that subject for that task. For example, a value of “0” may be assigned to a subject that does not submit an essay according to one embodiment.

Referring back to method 400, once the subjects in the group(s) complete the task 430, then the method 400 proceeds to block 440. In block 440, the subjects review and rank the essays submitted by other subjects in their group and provide textual feedback. For example, referring to FIG. 3, a subject in a group may provide rankings for the essays of other members of their group and/or textual feedback through an online website. In this embodiment, if the subject is using tablet computer 320, then the subject may be able to provide the rankings and textual feedback through the tablet computer 320. The tablet computer 320 may communicate with web server 350 through network 310 to send and receive information regarding the task, other subjects in the group, rankings, feedback, and any other necessary or useful information.

In one embodiment, each subject of a group provides rankings and textual feedback for every other subject in the group. For example, if a group comprises eight subjects, then each subject ranks the other seven subjects from best to worst and provides textual feedback to the seven subjects. In another embodiment, each subject of a group provides rankings and textual feedback to a subset of the other subjects in the group. Thus, in an embodiment, if a group comprises twenty-one subjects, then each subject may provide rankings and textual feedback to ten of the twenty other subjects. In one embodiment, the other subjects for which a particular subject is to provide rankings and textual feedback is selected randomly. In other embodiments, the other subjects for which a particular subject is to provide rankings and textual feedback is selected purposely based at least in part on previously-received criteria, previous results for the group, previous results for one or more subjects, and/or other information. In one embodiment, a subject providing rankings and feedback for another subject in a group may not know the author of the essay for which rankings and feedback are being provided. In another embodiment, a subject providing rankings and feedback for another subject in a group may know the author of the essay for which rankings and feedback are being provided.

Referring back to method 400, once the subjects in the group(s) rank the essays and submit textual feedback 440, the method 400 proceeds to block 450. In block 450, the subjects submit feedback evaluation for the textual feedback received. For example, referring to FIG. 3, a subject in a group may receive the ratings and textual feedback provided by other subjects in the group through a website. In this embodiment, if the subject is using tablet computer 320, then the subject may be able to receive the rankings and textual feedback through the tablet computer 320. The tablet computer 320 may receive the rankings and textual feedback by communicating with the web server 350 through network 310. Similarly, the subject may submit feedback evaluation regarding the textual feedback received using the tablet computer 320. For example, a subject may be presented with a form to fill out regarding the textual feedback received from the other subjects which can be completed and submitted to web server 350 through network 310 by using the tablet computer 320.

Referring back to method 400, once the subjects submit feedback evaluation for the textual feedback received 450, the method 400 proceeds to block 460. In block 460, scores for the subjects are calculated. For example, referring to FIG. 3, web server 350 may calculate scores for all or a subset of the subjects. A score for a subject may be calculated in any number of ways. Illustrative models for calculating various scores are described below in the Illustrative Score Generation Models section.

Referring back to method 400, once the scores for the subjects have been calculated 460, the method 400 proceeds to block 470. In block 470, all or a portion of the blocks described above with respect to method 400 are repeated. For example, if new groups will be formed, then the method 400 may be repeated beginning with block 410. As another example, if the same groups will be maintained, then the method 400 may be repeated beginning with block 420.

Preconditions

In one embodiment, a DLMA method complies with the following validity preconditions if a summative assessment ranking mode is selected.

In an embodiment, the observed within-group distribution of the average scores based on ranking summative assessment of essays approximates the latent distribution of the quality of essays within a peer group.

In an embodiment, the observed within-group distribution of the average scores based on ranking (relative-scale, or forced-distribution) summative assessment of textual feedback approximates the latent distribution of the quality of verbal feedback within a peer group.

In an embodiment, the observed within-group distribution of the sum of the average scores for essay and verbal feedback based on ranking approximates the latent distribution of the current level of competency within a peer group.

In an embodiment, the observed pool-wide distribution of the sum of the average scores for essay and verbal feedback based on ranking approximates the latent distribution of the current level of competency in the pool of subjects.

In an embodiment, over a series of tasks, the observed pool-wide distribution of the cumulative sum of the average scores for essay and verbal feedback based on ranking approximates the latent distribution of the terminal level of competency in the pool of subjects.

In one embodiment, a DLMA method complies with the following validity preconditions if a summative assessment rating mode is selected.

In an embodiment, the observed within-group distribution of the average scores based on rating summative assessment of essays approximates the latent distribution of the quality of essays within a peer group.

In an embodiment, the observed within-group distribution of the average scores based on rating (absolute-scale, Likert scale, etc.) summative assessment of textual feedback approximates the latent distribution of the quality of verbal feedback within a peer group.

In an embodiment, the observed within-group distribution of the sum of the average scores for essay and verbal feedback based on rating approximates the latent distribution of the current level of competency within a peer group.

In an embodiment, for a given task, the observed pool-wide distribution of the sum of the average scores for essay and verbal feedback based on rating approximates the latent distribution of the current level of competency in the pool of subjects.

In an embodiment, over a series of tasks, the observed pool-wide distribution of the cumulative sum of the average scores for essay and verbal feedback based on rating approximates the latent distribution of the terminal level of competency in the pool of subjects.

In other embodiments, one or more of the validity preconditions described above does not need to be met. In yet another embodiment, none of the validity preconditions described above are required. In addition, variations of the preconditions described above are within the scope of this disclosure.

### Illustrative Score Generation Models

The following score generation models described below are illustrative score generation models and, for simplicity, are described with respect to students in classroom. The models, however, may be used in numerous other contexts. Numerous variations to the models described below are disclosed herein and variations are within the scope of this disclosure. Those of ordinary skill in the art will realize that the following description is illustrative only and is not intended to be in any way limiting.

Model 1

In the embodiment of Model 1, a class of N students work independently on a single common assignment or project requiring a submission of an essay. In this embodiment, N is generally a relatively small number such as 6 or below; however, larger numbers are within the scope of this disclosure. In the embodiment of Model 1, the rankings of essays are selected from a continuum of most satisfactory to least satisfactory or another suitable ranking. In this embodiment, each student's essay is collected, or otherwise submitted, and distributed anonymously among the other students in the class. Thus, in the embodiment of Model 1, each essay is distributed to (N−1) students for review and every student in the class has to read, review, and assess everyone else's essay in the class without knowing the identities of the authors.

After reviewing all of the other students' essays, each student ranks or otherwise orders each essay (other than the student's own essay). In one embodiment, the student submits a ranking of each student's essay among the other students' essays. Thus, the “best” essay (according to the student's evaluation) may receive a ranking of “1” and the “worst” ranked essay may receive a ranking of (N−1). In an embodiment, the student also submits textual qualitative feedback commenting on the overall quality of each subject's essay. In this embodiment, the identify of the author of the feedback is not revealed to the recipient of the feedback. In other embodiments, however, the author of the feedback is revealed to the recipient of the feedback.

After the feedback from the students have been submitted, each student receives back everyone else's feedback to the student's essay. Thus, in an embodiment, a student receives (N−1) pieces of feedback regarding the essay that the student submitted. The student then reviews the feedback and submits a ranking for each individual feedback. For example, a “1” may be given to the “most helpful and professional” feedback and (N−1) may be given to the “least helpful and professional” feedback.

Suppose, according to an embodiment, that there are N students in a class indexed i={1, 2, . . . , N}. In this embodiment, a student i ranks, or otherwise orders, (N−1) other students' essays so that the “best” gets the rank of 1 and the “worst” gets the rank of (N−1). In this embodiment, a student i does not rank-order his/her own essay among others. In such an embodiment, a matrix of ranks of essays produced by the class (scores given are in rows) can be specified as:

$${A}_{N \times N} = {[ {a}_{ij} ]}_{N \times N} = [ \begin{matrix}\begin{matrix}N & {a}_{12} \\ {a}_{21} & N\end{matrix} & … & \begin{matrix}{a}_{1 N} \\ {a}_{2 N}\end{matrix} \\ ⋮ & ⋱ & ⋮ \\ \begin{matrix}{a}_{N 1} & {a}_{N 2}\end{matrix} & … & N\end{matrix} ]$$

where aᵢⱼ denotes a rank given by a student i to a student j for the essay (or, symmetrically, received by a student j from a student i).

In this embodiment, aᵢ=[aᵢ₁ aᵢ₂ . . . aᵢⱼ . . . a_{iN}] is a row vector of ranks given by student i to all other students such that

$$\{ \begin{matrix}{a}_{ij} = N if i = j \\ {a}_{ij} ∈ \{ 1 , 2 , … , N - 1 \} if i = j \\ {a}_{i 1} \neq {a}_{i 2} \neq … \neq {a}_{ij} \neq … \neq {a}_{iN} \\ {a}_{ij} = N if {E}_{j} = 0\end{matrix}$$

where Eⱼ is the indicator function such that

$${E}_{j} = \{ \begin{matrix}1 & if essay was submitted by student j \\ 0 & if essay was not submitted by student j .\end{matrix}$$

Thus, in an embodiment, a student i does not give a rank to him/her-self or to a student who did not submit the essay, each of the students need to be ranked (or otherwise ordered) by the student i, and the student i cannot give two students the same rank.

Similarly, matrix of ranks of feedbacks produced by the class is (scores given are in rows):

$${B}_{N \times N} = {[ {b}_{ij} ]}_{N \times N} = [ \begin{matrix}\begin{matrix}N & {b}_{i 2} \\ {b}_{2 i} & N\end{matrix} & … & \begin{matrix}{b}_{iN} \\ {b}_{2 N}\end{matrix} \\ ⋮ & ⋱ & ⋮ \\ \begin{matrix}{b}_{N 1} & {b}_{N 3}\end{matrix} & … & N\end{matrix} ]$$

subject to the data integrity constraints:

$$\{ \begin{matrix}{b}_{ij} = N if i = j \\ {b}_{ij} ∈ \{ 1 , 2 , … , N - 1 \} if i \neq j \\ {b}_{i 1} \neq {b}_{i 2} \neq … \neq {b}_{ij} \neq … \neq {b}_{iN} \\ {b}_{ij} = N if {F}_{j} = 0\end{matrix}$$

where Fⱼ is the indicator function such that

$${E}_{j} = \{ \begin{matrix}1 & if essay was submitted by student j \\ 0 & if essay was not submitted by student j .\end{matrix}$$

According to an embodiment, if C is the maximum score for the essay (i.e. C is given to an essay that received the rank of 1) and if an essay that received the rank of (N−1) receives the score of 1 and if any essays that were not submitted receive a score of 0, then the rank of aᵢⱼ may be transformed into a score cᵢⱼ:

$${c}_{ji} = 1 + ( N - {a}_{ij} - 1 ) \frac{C - 1}{N - 2}$$

or, equivalently,

$${c}_{ji} = {a}_{ij} \frac{( 1 - C )}{N - 2} + \frac{C ( N - 1 ) - 1}{N - 2}$$

For example, if N=6 students and C=5 points, then a transformation rule according to one embodiment may be:

| Rank aᵢⱼ | Score cᵢⱼ |
|---|---|
| 1 | 5 |
| 2 | 4 |
| 3 | 3 |
| 4 | 2 |
| 5 | 1 |
| Not submitted (6) | 0 |

Similarly, if D is the maximum score for feedback (i.e. D is given to a piece of feedback that received the rank of 1) and a failure to submit feedback results is given a score of 0, then a transformation rule for rank bᵢⱼ into the score dᵢⱼ according to one embodiment is:

$${d}_{ji} = 1 + ( N - {b}_{ij} - 1 ) \frac{D - 1}{N - 2}$$

or, equivalently,

$${d}_{ji} = {b}_{ij} \frac{( 1 - D )}{N - 2} + \frac{D ( N - 1 ) - 1}{N - 2}$$

Therefore, in some embodiments, C and D reflect relative weights given to the scores for the essay and feedback in the total grade for the assignment.

In one embodiment, the matrix of the individual received essay scores for the entire class is (scores received are in rows):

$${C}_{N \times N} = {A}_{N \times N}^{′} \frac{( 1 - C )}{N - 2} + \frac{C ( N - 1 ) - 1}{N - 2}$$

In an embodiment, the matrix of the individual given-received feedback scores for the entire class is (scores received are in rows):

$${D}_{N \times N} = {B}_{N \times N}^{′} \frac{( 1 - D )}{N - 2} + \frac{D ( N - 1 ) - 1}{N - 2}$$

According to one embodiment, a student i's grade for the essay is the average score received from all his/her peers, who submitted their feedback, ideally (NM. Hence, in an embodiment, the column vector of grades for essays is:

$$\overline{c} = \frac{{C}_{N \times N} {1}^{′}}{{\sum }_{j = 1}^{N - 1} {F}_{j}}$$

where Σⱼ₌₁^{N-1}Eⱼ≦N−1, and 1_{1×N}=[1 1 . . . 1] is the row vector of ones.

In one embodiment, the grade for the essay of a student i is

$${\overline{c}}_{i} = \frac{{c}_{{i}_{1 \times N}} {1}^{′}}{{\sum }_{j = 1}^{N - 1} {F}_{j}}$$

where Cᵢ_{_{1×N}} is the row vector of essay scores received by the student i.

Similarly, the column vector of grades for feedback according to one embodiment is:

$$\overline{d} = \frac{{D}_{N \times N} {1}^{′}}{{\sum }_{j = 1}^{N - 1} {G}_{j}}$$

In an embodiment, the grade for the feedback of a student i is:

$${\overline{d}}_{i} = \frac{{d}_{{i}_{1 \times N}} {1}^{′}}{{\sum }_{j = 1}^{N - 1} {G}_{j}}$$

where dᵢ_{_{1×N}} is the row vector of essay scores received by the student i,
Gⱼ is the indicator function such that

$${G}_{i} = \{ \begin{matrix}1 if evaluation of feedback was submitted by a student j \\ 0 if evaluation of feedback was not submitted by a student j \\ {G}_{j} = 0 if {E}_{j} = 0 ( \begin{matrix}if a student did not submit essay , \\ she should not evaluate feedback\end{matrix} ) . \end{matrix}$$

According to one embodiment, the total grade received by a student i is:

pᵢ= c̅ᵢ+ d̅ᵢ,

In one embodiment the vector of total grades for the assignment of the entire class is:

p= c̅+ d̅.

Model 2

The embodiment of Model 2 is an extension of Model 1. In Model 2, instead of a single common assignment as described above with respect to Model 1, the class is given several sequential assignments indexed by k. In this embodiment, the calculations described for Model 1 repeat K times producing matrices Aₖ_{_{N×N}}, Bₖ_{_{N×N}}, Cₖ_{_{N×N}}, Dₖ_{_{N×N}}, where k={1, 2, . . . , K}.

In the embodiment of Model 2, the vector of total grades for the assignment k of the entire class is:

pₖ= c̅ₖ+ d̅ₖ,

In the embodiment of Model 2, the vector of total grades for the entire course (all assignments) of the entire class is:

p=Σₖ₌₁^{K}pₖ=Σₖ₌₁^{K} c̅ₖ+Σₖ₌₁^{K} d̅ₖ.

Model 3

The embodiment of Model 3 is an extension of Model 1. In Model 3, a class consists of several (L) groups of an approximately equal size Nᵢ; groups are indexed by l. For example, in one embodiment, L is selected such that Nₗ is 6. In another embodiment, L is selected such that Nₗ is a number greater than 6. In yet another embodiment, L is selected such that Nₗ is a number less than 6. Therefore, in various embodiments, L can be selected to be any suitable number.

In the embodiment of Model 3, the calculations discussed above with respect to Model 1 are performed for each of L groups (replacing N with Nₗ), producing matrices Aₗ_{_{N×N}}, Bₗ_{_{N×N}}, Cₗ_{_{N×N}}, Dₗ_{_{N×N}} where l={1, 2, . . . , L}.

In the embodiment of Model 3, the vector of total grades for the assignment of the entire class is:

$$p = [ \begin{matrix}{\overline{c}}_{1} \\ {\overline{c}}_{2} \\ ⋮ \\ {\overline{c}}_{L}\end{matrix} ] + [ \begin{matrix}{\overline{d}}_{1} \\ {\overline{d}}_{2} \\ ⋮ \\ {\overline{d}}_{L}\end{matrix} ] ,$$

Therefore, in the embodiment of Model 3, the column vectors of grades of each group c̅ₗ are stacked into a “tall” column vector of grades for the entire class.

Model 4

The embodiment of Model 4 comprises a hybrid of Model 2 and Model 3. In Model 4, the class is given several sequential assignments indexed by k={1, 2, . . . , K} (with all assumptions of Model 2). In addition, for each assignment, the class (of size M) is divided into L groups of the size of Nₗ indexed by l={1, 2, . . . , L} (with all assumptions of Model 3); M=Σ_{L}^{l=1}Nₗ. Furthermore, in Model 4, for each of the assignments, students are divided into groups randomly, so that for each assignment a student is given a new random group of peers. Finally, specific projects given to groups may be the same for the entire class or individual for each group; in any case, student within each group work on the same group-specific project (independently, i.e. with no collaboration within the group).

In the embodiment of Model 4, for each assignment k, a student i receives a grade pₖᵢ, based on calculations described in Model 2, thus:

pₖᵢ= c̅ₖᵢ+ d̅ₖᵢ.

In the embodiment of Model 4, the row vector of the student i's grades for all assignments is:

pᵢ=[p₁ᵢp₂ᵢ . . . p_{Ki}].

In the embodiment of Model 4, the student i's total grade is:

pᵢ=Σₖ₌₁^{K}pₖᵢ=pᵢ1_{1×K}

Relationship Between Models 1-4

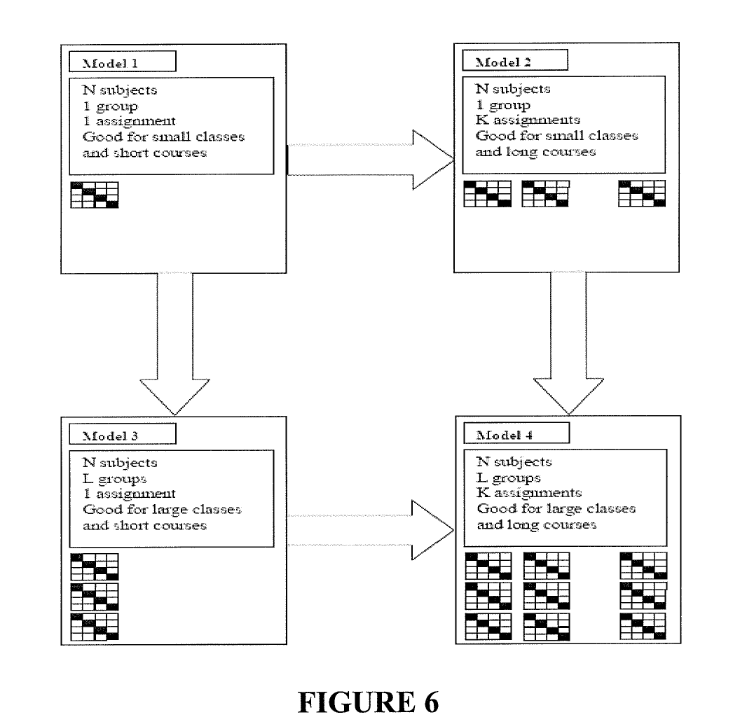

Referring now to FIG. 6, this figure depicts a logical relationship of algebraic models of a DLMA score generation process according to an embodiment of the present invention. In the embodiment shown in FIG. 6, Model 1 comprises N subjects, a single group, and a single assignment. Therefore, Model 1 may be appropriate to use in a small class and short courses. In FIG. 6, Model 2 comprises N subjects, a single group, and K assignments. Thus, Model 2 may be appropriate for use in small classes and long courses. In FIG. 6, Model 3 comprises N subjects, L groups, and a single assignment. Therefore, Model 3 may be appropriate for large classes and short courses. In the embodiment shown in FIG. 6, Model 4 comprises N subjects, L groups, and K assignments. Thus, Model 4 may be appropriate for large classes and long courses.

Model 5

The embodiment of Model 5 is an extension of Model 4. In Model 5, peers' essays are ranked, or otherwise ordered, based on several specified criteria indexed by u={1, 2, . . . , U}. In the embodiment of Model 5, criteria are assumed to be the same for all assignments. However, variations of the present invention in which criteria are different for one or more assignments is within the scope of this disclosure. In the embodiment of Model 5 peers' feedback is ranked based on several criteria indexed by v={1, 2, . . . , V}. In various embodiments, Models 1, 2 and 3 can be extended in a similar fashion to utilize multiple criteria for grading.

In Model 5, for an assignment k, for a given group l of the size Nₗ, the matrix of ranks of essays based on a criterion u is:

$${A}_{{ulk}_{N \times N}} = {[ {a}_{ulkij} ]}_{N \times N} = [ \begin{matrix}0 & {a}_{ulki 2} & … & {a}_{ulk 1 N} \\ {a}_{ulk 2 i} & 0 & … & {a}_{ulk 2 N} \\ ⋮ & ⋮ & ⋱ & ⋮ \\ {a}_{ulkN 1} & {a}_{ulkN 2} & … & 0\end{matrix} ]$$

where aᵤₗₖᵢⱼ is the rank given by a student i to the essay of a student j in a group l on an assignment k based on an essay criterion u.

In one embodiment, Matrix Bᵥₗₖ_{_{N×M}} is defined similarly, with bᵥₗₖᵢⱼ being the rank given by a student i to the feedback of a student j in a group/on an assignment k bases on a feedback criterion v. In this embodiment, the matrices of scores for each criterion u and v, Cᵤₗₖ_{_{N×N}} and Dᵤₗₖ_{_{N×N}} respectively, can be defined as described in the Model 1, assuming that the maximum possible score is the same for all criteria. According to one embodiment, the matrices of scores aggregating all criteria for a group l and assignment k are defined as weighted averages of the matrices of scores for individual criteria:

$${C}_{{lk}_{N \times N}} = \frac{{\sum }_{u = 1}^{u} {C}_{{ulk}_{N \times N}} {w}_{u}}{{\sum }_{u = 1}^{u} {w}_{u}}$$

$${D}_{{lk}_{N \times N}} = \frac{{\sum }_{v = 1}^{v} {D}_{{vlk}_{N \times N}} {z}_{v}}{{\sum }_{v = 1}^{v} {w}_{u}}$$

where wᵤ is the weight of a criterion u in the essay grade and zᵥ is the weight of criterion v in the feedback grade.

In the embodiment of Model 5, the column vector of grades for a group/for essays in an assignment k is:

$${\overline{c}}_{lk} = \frac{{c}_{{lk}_{N \times N}} {1}^{′}}{{\sum }_{i = 1}^{N - 1} {E}_{i}}$$

In the embodiment of Model 5, the column vector of grades for a group/for feedback in an assignment k is:

$${\overline{d}}_{lk} = \frac{{d}_{{lk}_{N \times N}} {1}^{′}}{{\sum }_{i = 1}^{N - 1} {F}_{i}}$$

In the embodiment of Model 5, the vector of total grades for the assignment k of the entire class is:

$${p}_{k} = [ \begin{matrix}{\overline{c}}_{1 k} \\ {\overline{c}}_{2 k} \\ ⋮ \\ {\overline{c}}_{Lk}\end{matrix} ] + [ \begin{matrix}{\overline{d}}_{1 k} \\ {\overline{d}}_{2 k} \\ ⋮ \\ {\overline{d}}_{Lk}\end{matrix} ] .$$

Thus, in this embodiment, the column vectors of grades of each group c̅ₗ are stacked into a “tall” column vector of grades for the entire class.

In the embodiment of Model 5, the total grade received by a student i for an assignment k is:

pₖᵢ= c̅ₖᵢ+ d̅ₖᵢ.

In the embodiment of Model 5, the row vector of the student i's grades for all assignments is:

pᵢ=[p₁ᵢp₂ᵢ . . . p_{Ki}].

In the embodiment of Model 5, the student i's total grade of for the entire course (that is, for all assignments) is:

pᵢ=Σₖ₌₁^{K}pₖᵢ=pᵢ1_{1×K}

Here, an assumption has been made that all assignments have the same weight. If all assignments do not have the same weight, then weighting coefficients can be added to the equation (e.g., by replacing the vector of 1s, 1_{1×K}, with the vector of assignment weights).

Variations

Variations of the score generating processes described above and/or the various models described above are within the scope of the present disclosure. For example, according to one embodiment, data integrity assumptions aᵢ₁≠aᵢ₂≠ . . . ≠aᵢⱼ≠ . . . ≠a_{iN} and bᵢ₁≠bᵢ₂≠ . . . ≠bᵢⱼ≠ . . . ≠b_{iN} may be relaxed. Such an embodiment can allow each essay and feedback to be rated rather than ranked. As another example, the random allocation of subjects to groups may be replaced with non-random allocation to groups. In such an embodiment, more complex scoring approaches may be used such as higher scoring students being placed in the same group to intensify competition.

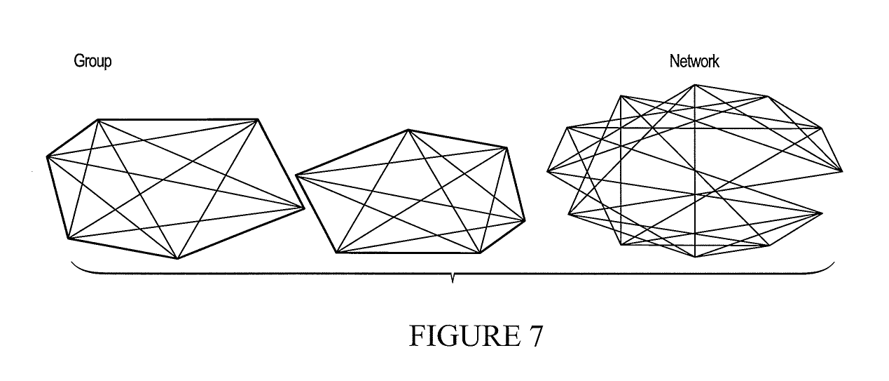

In one embodiment, the identity of the subject authoring an essay and/or the identify of the subject providing rankings and/or feedback for an essay is provided. In such an embodiment, one or more DLMA methods may be used to assess individual contributions to group projects. In another embodiment, a dyad of peers may be formed within an open network. For example, group randomization may be replaced with network randomization. Thus, in a class of 12 students, dyads may be formed based on the schema shown in FIG. 7 which depicts an example dyad formation in closed groups and on networks. Numerous other embodiments and variations are disclosed herein and other variations are within the scope of this disclosure.

### General

While the methods and systems herein are described in terms of software executing on various machines, the methods and systems may also be implemented as specifically-configured hardware, such as field-programmable gate array (FPGA) specifically to execute the various methods. For example, embodiments can be implemented in digital electronic circuitry, or in computer hardware, firmware, software, or in a combination thereof. In one embodiment, a device may comprise a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the invention.

Reference herein to “one embodiment” or “an embodiment” means that a particular feature, structure, operation, or other characteristic described in connection with the embodiment may be included in at least one implementation of the invention. The invention is not restricted to the particular embodiments described as such. The appearance of the phrase “in one embodiment” or “in an embodiment” in various places in the specification does not necessarily refer to the same embodiment. Any particular feature, structure, operation, or other characteristic described in this specification in relation to “one embodiment” may be combined with other features, structures, operations, or other characteristics described in respect of any other embodiment.

What is claimed is:

1. A method comprising:
receiving, from each of a plurality of subjects, an essay authored by that subject;
receiving, from each of the subjects, an essay ranking and a textual feedback statement for each of a respective subset of the received essays, each essay ranking and each textual feedback statement corresponding to one of the essays authored by one of the subjects;
receiving, from each of the subjects, a feedback ranking for each of a respective subset of the received feedback statements, each feedback statement in that respective subset corresponding to the received essay authored by that subject;
calculating, for at least one of the subjects, a grade for that subject based at least in part on the received essay ratings corresponding to the received essay authored by that subject and the received feedback ratings for the feedback statements for that subject.

2. The method of claim 1, further comprising:
dividing a pool of subjects into at least two groups, one of the groups comprising the plurality of subjects, each group having approximately a same number of subjects; and
assigning, for each of the groups, a respective task requiring that each subject in that group author a respective essay.

3. The method of claim 2, wherein the respective task for each of the groups is a same task.

4. The method of claim 2, wherein the respective task for a first group in the at least two groups is a different task than the respective task for a second group in the at least two groups.

5. The method of claim 1, wherein the grade for a particular subject in the at least one subject is based at least in part on two or more tasks.

6. The method of claim 1, wherein the respective subset of the received essays for a particular subject comprises each of the received essays except for the received essay authored by that particular subject.

7. The method of claim 1, wherein the respective subset of the received essays for a particular subject comprises the received essay authored by that particular subject.

8. The method of claim 1, wherein an author of an essay in the respective subset of the received essays for a particular subject is unknown to that particular subject.

9. The method of claim 1, wherein the respective subset of the received feedback statements for a particular subject comprises each of the received feedback statements corresponding to the received essay authored by that subject.

10. The method of claim 1, wherein the received essay rankings for the respective subset of the received essays for a particular subject represent a continuum from a most satisfactory essay to a least satisfactory essay.

11. The method of claim 1, wherein calculating, for at least one of the subjects, a grade for that subject comprises calculating a vector of total grades for the plurality of subjects.

12. A non-transitory computer-readable medium comprising program code for:
receiving, from each of a plurality of subjects, an essay authored by that subject;
receiving, from each of the subjects, an essay ranking and a textual feedback statement for each of a respective subset of the received essays, each essay ranking and each textual feedback statement corresponding to one of the essays authored by one of the subjects;
receiving, from each of the subjects, a feedback ranking for each of a respective subset of the received feedback statements, each feedback statement in the respective subset corresponding to the received essay authored by that subject; and
calculating, for at least one of the subjects, a grade for that subject based at least in part on the received essay ratings corresponding to the received essay authored by that subject and the received feedback ratings for the feedback statements for that subject.

13. The non-transitory computer-readable medium of claim 12, further comprising program code for:
dividing a pool of subjects into at least two groups, one of the groups comprising the plurality of subjects; and
assigning, for each of the groups, a respective task requiring that each subject in that group author a respective essay.

14. The non-transitory computer-readable medium of claim 13, wherein the respective task for each of the groups is a same task.

15. The non-transitory computer-readable medium of claim 13, wherein the grade for a particular subject in the at least one subject is based at least in part on two or more tasks.

16. The non-transitory computer-readable medium of claim 12, wherein the respective task for a first group in the at least two groups is a different task than the respective task for second group in the at least two groups.

17. The non-transitory computer-readable medium of claim 12, wherein the respective subset of the received essays for a particular subject comprises each of the received essays except for the received essay authored by that particular subject.

18. The non-transitory computer-readable medium of claim 12, wherein the respective subset of the received essays for a particular subject comprises the received essay authored by that particular subject.

19. The non-transitory computer-readable medium of claim 12, wherein calculating, for at least one of the subjects, a grade for that subject comprises calculating a vector of total grades for the plurality of subjects.

20. A system comprising:
a network;
a plurality of electronic devices in communication with the network; and
a server in communication with the network, the server comprising a memory, a network interface, and a processor in communication with the memory and the network interface, the processor configured for:
receiving, from each of a plurality of subjects and from one or more of the electronic devices in communication with the network, an essay authored by that subject;
receiving, from each of the subjects and from one or more of the electronic devices in communication with the network, an essay ranking and a textual feedback statement for each of a respective subset of the received essays, each essay ranking and each textual feedback statement corresponding to one of the essays authored by one of the subjects;
receiving, from each of the subjects and from one or more of the electronic devices in communication with the network, a feedback ranking for each of a respective subset of the received feedback statements, each feedback statement in the respective subset corresponding to the received essay authored by that subject; and
calculating, for at least one of the subjects, a grade for that subject based at least in part on the received essay ratings corresponding to the received essay authored by that subject and the received feedback ratings for the feedback statements for that subject.
